(19) United States
(12) Patent Application Publication
(10) Pub. No.: US 2019/0063067 A1
(43) Pub. Date: Feb. 28, 2019

(54) Flexible Elastomer And Fiberglass Layered Building Element

(71) Applicant: TopFiberRoof, LLC, Columbia, MD (US)

(72) Inventor: Jean Gilman, IV, Stevensville, MD (US)

(21) Appl. No.: 15/687,724

(22) Filed: Aug. 28, 2017

(51) Int. Cl. E04D 5/08; E04B 1/62; E04D 1/28; E04D 1/22; E04C 2/26; B62D 65/02; B61D 17/00; B32B 5/02; B32B 17/06; C03C 17/32

(52) U.S. Cl. CPC E04D 5/08; E04B 1/62; E04D 1/28; E04D 1/22; E04C 2/26; B62D 65/024; B32B 2419/06; B32B 5/022; B32B 17/063; C03C 17/322; B32B 2260/021; B32B 2260/048; B61D 17/005

(57) ABSTRACT

A layered building element for protecting exterior or interior building surfaces is disclosed. Exterior or interior surfaces may include both vertical and horizontal surfaces, such as walls, roofs, or floors. The layered building element includes a flexible sheet comprising at least one elastomer layer in communication with an elastomer-impregnated fiberglass layer. Each elastomer layer may be bound in communication to the fiberglass layer at an interface comprising elastomer-impregnated fiberglass. The flexible sheet may form, for example, shingles, tiles, or a cylindrical roll, which may support portability and installation of the layered building element.

### BACKGROUND OF THE INVENTION

Building structures may include multiple exterior surfaces, such as wall surfaces and roof surfaces. Natural elements, such as rain, wind, snow, sunlight, or hail, may attack these exterior surfaces. These attacks may weaken the structures protected by these exterior surfaces. Indeed, weaknesses in the exterior surfaces may lead to extensive and costly damage at the exterior surface and within the building structure. Weaknesses in the exterior surface may, for example, lead to interior and exterior water damage, which may require, at least, interior flooring repairs. Exterior surface weaknesses may be amplified based on slope or incline of the exterior surface relative to the natural elements. For example, exterior walls and roof surfaces may experience surface leaks at different rates and for different reasons. Accordingly, natural elements may weaken exterior surface integrity, which may result in both interior and exterior structural damage.

Exterior surfaces may also weaken with use. In some cases, such as flat roofs, use may include more than mere natural element impacts. Use may also include, for example, wear and tear due to foot traffic. Similarly, interior surfaces may weaken with, for example, water damage or use. Protecting interior and exterior surfaces from, for example, natural elements, water damage, or traffic, may be necessary to protect both interior and exterior structures. At the same time, decorative properties may be considered when protecting both interior and exterior surfaces. Accordingly, means for protecting interior and exterior surfaces may necessarily consider at least strength, waterproofing, or ultra violet protective characteristics.

### SUMMARY OF THE PRESENT INVENTION

Various exemplary embodiments of the present disclosure may demonstrate one or more of the invention features. Other features and advantages of this invention will become apparent from the following detailed description of the presently preferred embodiment of the invention, taken in conjunction with the accompanying drawings.

In accordance with an exemplary embodiment, a layered building element may include a flexible sheet. The flexible sheet may comprise a first layer in communication with a second layer. The first layer may comprise an elastomer and the second layer may comprise a first fiberglass impregnated with the elastomer.

In accordance with another exemplary embodiment, a method of making a layered building element described above may include applying an elastomer to a fiberglass layer. The fiberglass layer may be impregnated with a first amount of the applied elastomer. A second amount of the applied elastomer may form an elastomer layer in communication with the fiberglass layer. The communicating layers may be formed into a flexible sheet.

In accordance with a further exemplary embodiment, a method of installing a layered building element described above may include preparing a flexible sheet for installation and applying the flexible sheet to a surface.

It is to be understood that both the foregoing general description and the following detailed description are exemplary and explanatory only and are not restrictive of the present disclosure or claims.

### BRIEF DESCRIPTION OF THE DRAWINGS

The drawings referenced herein are incorporated in and form part of the specification. The drawings illustrate one or more exemplary embodiments of the present disclosure and together with the description serve to explain various principles and operations. Implications that the drawings illustrate all embodiments of the invention are not to be made.

FIGS. 1A-1C illustrate cross-sectional views of exemplary embodiments of a layered building element.

FIG. 2 illustrates a flow diagram showing making a layered building element.

FIG. 3 illustrates a flow diagram showing installing a layered building element.

FIG. 4 illustrates a perspective view showing unrolling a substantially cylindrical roll of a layered building element.

### DETAILED DESCRIPTION OF THE INVENTION

Reference will now be made in detail to various exemplary embodiments of the present disclosure, examples of which are illustrated in the accompanying drawings.

It will be readily understood that the components of the present invention, as generally described and illustrated in the figures herein, may be arranged and designed in a wide variety of different configurations. Thus, the following detailed description of the embodiments of the layered building element and methods of the present invention, as presented in the figures, is not intended to limit the scope of the invention, as claimed, but is merely representative of selected embodiments of the invention.

Reference throughout this specification to “a select embodiment,” “one embodiment,” or “an embodiment” means that a particular feature, structure, or characteristic described in connection with the embodiment is included in at least one embodiment of the present invention. Thus, appearance of the phrases “a select embodiment,” “in one embodiment,” or “in an embodiment” in various places throughout this specification are not necessarily referring to the same embodiment.

Features, structure, or characteristics described herein may be combined in any suitable manner in one or more embodiments. One skilled in the relevant art will recognize, however, that the invention may be practiced without one or more of the specific details, or with other methods, components, or materials. In other instances, well-known materials or processes are not shown or described in detail to avoid obscuring aspects of the invention. The following description, which shows by way of illustration the specific embodiment in which the invention may be practiced, is intended only by way of example. That is, the following description simply illustrates certain selected embodiments of a layered building element and methods that are consistent with the invention as claimed herein. It is to be understood that other embodiments may be utilized because structural and process changes may be made without departing from the scope of the present invention.

Elastomers are chemical compounds that form rubber like materials. These materials may be recognized for flexibility, strength, and waterproofing characteristics. Examples of elastomers may include polyurea, polyurethane, and combinations thereof. Other examples of elastomers are contemplated by the present disclosure. Fiberglass, a material comprising fibrous lengths of glass, may be recognized for its strength, low weight, and dimensional stability. Composite materials comprising both elastomers and fiberglass may leverage the characteristics of the individual components to provide enhanced flexibility, strength, and waterproofing characteristics. Similarly, composite materials comprising both elastomer and fiberglass may leverage decorative characteristics of, for example, cured elastaomer. Accordingly, a composite of elastomer and fiberglass may leverage individual component capabilities, such as strength, flexibility, waterproofing, low weight, and dimensional stability.

Building surface protective membranes, for interior or exterior surfaces, may leverage elastomer-fiberglass composites for the characteristics described above. In an embodiment of the present invention, an interior or exterior building surface protective membrane may comprise an elastomer topcoat layer and at least one fiberglass layer. In another exemplary embodiment, a building surface protection membrane may comprise an elastomer topcoat layer, at least one fiberglass layer, and an elastomer basecoat layer. In an exemplary embodiment of the present invention, polyurea, polyurethane, or a combination thereof may form an elastomer layer. The topcoat or basecoat elastomer layer may provide, for example, strength, ultra violet, and waterproofing capabilities to the protective membrane. As a result, the protective membrane may minimize exterior surface weaknesses from, for example, natural elements and wear and tear. Similarly, the protective membrane may minimize interior surface weaknesses from, for example, water damage and wear and tear. Accordingly, elastomer capabilities may support building surface protective membrane functions.

In an exemplary embodiment, a protective membrane may comprise at least one elastomer layer and a fiberglass layer. The fiberglass layer may provide, for example, strength and dimensional stability capabilities, in addition to the elastomer layer capabilities, to the protective membrane. In an exemplary embodiment of the present invention, an elastomer-fiberglass composite may comprise single or multiple layers of fiberglass. Any given layer may comprise cloth, mat, or veil forms. For example, veil mat fiberglass may comprise, for example, thin plies of continuous strands of fibers randomly looped into a sheet with the thickness and consistency of tissue paper not intended to be structural. Chopped strand mat may comprise, for example, 3-4 inch fibers, not highly strong but equally strong in all directions. Woven fiberglass fabric may comprise enhanced structural properties relative to the veil mat or chopped stranded fiberglass. Fiberglass strands may, for example, be bundled and orientated to achieve strength in two directions or multiple directions depending on the orientation. Accordingly, a single fiberglass layer or multiple fiberglass layers may comprise structural characteristics to achieve desired characteristics for a protective membrane.

In an exemplary embodiment of the present invention, a combination of at least one elastomer layer and at least one fiberglass layer may form a low weight, flexible composite protective membrane. Low weight and flexibility characteristics may ease portability and installation of either an interior or exterior surface protective membrane. Accordingly, a composite of at least one elastomer layer and at least one fiberglass layer may support building surface protective membrane installation.

In an embodiment of the present invention, an interior or exterior surface protective membrane may comprise a building element, and the building element may comprise a composite of at least one elastomer layer bound to at least one fiberglass layer. In an exemplary embodiment, a firstelastomer layer may be bound to a first side of a first fiberglass layer. In another embodiment, for example, a first elastomer layer may be bound to a first side of a first fiberglass layer and a second elastomer layer may be bound to a second side of the first fiberglass layer. In a further exemplary embodiment, a first elastomer layer may be bound to a first side of a first fiberglass layer, and a second elastomer layer may be bound to a second side of a second fiberglass layer. In an even further exemplary embodiment, a first elastomer layer may be bound to a first side of a first fiberglass layer; a second elastomer layer may be bound to a second side of the first fiberglass layer and may be bound to a first side of a second fiberglass layer; and a third elastomer layer may be bound to a second side of the second fiberglass layer. The number of either elastomer layers or fiberglass layers described herein is provided for exemplary purposes, and is not meant to be limiting. The number of either elastomer or fiberglass layers may reflect, for example, desired properties of a building element as a protective membrane of interior and exterior surfaces, such as strength and waterproofing characteristics. Accordingly, a building element comprising at least one elastomer layer and at least one fiberglass layer may form a protective membrane for interior and exterior building surfaces.

The binding of elastomer and fiberglass layers may maintain composite integrity of the protective membrane. In an exemplary embodiment, elastomer from an elastomer layer may impregnate a fiberglass layer. The resulting matrix of elastomer and fiberglass may bind the elastomer layer to the fiberglass layer. The fiberglass layer may adopt some of the characteristics of the elastomer layer, such as enhanced strength and waterproofing. Accordingly, a composite comprising at least one elastomer layer and at least one elastomer-impregnated fiberglass layer may form an interior or exterior building surface protective membrane with protective capabilities enhanced relative to either an elastomer layer or a fiberglass layer, individually.

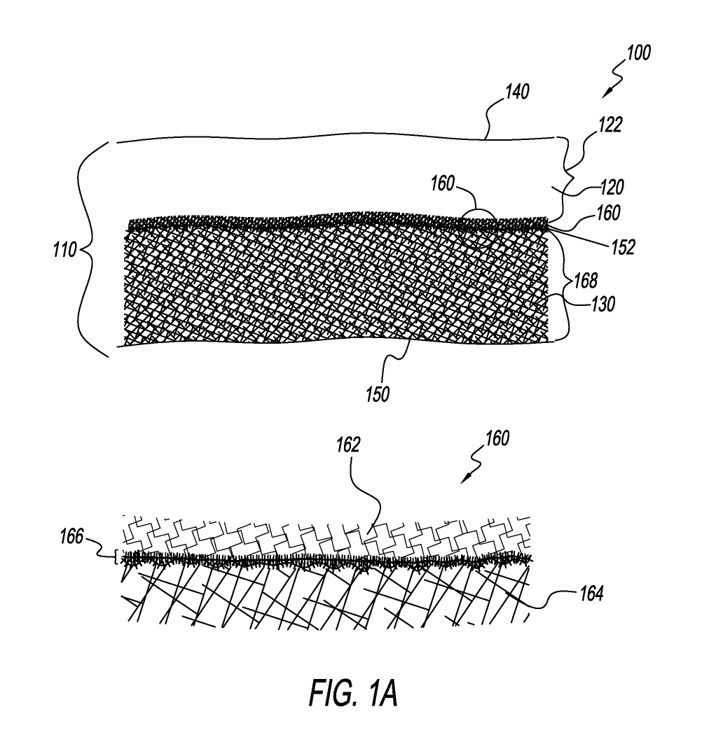

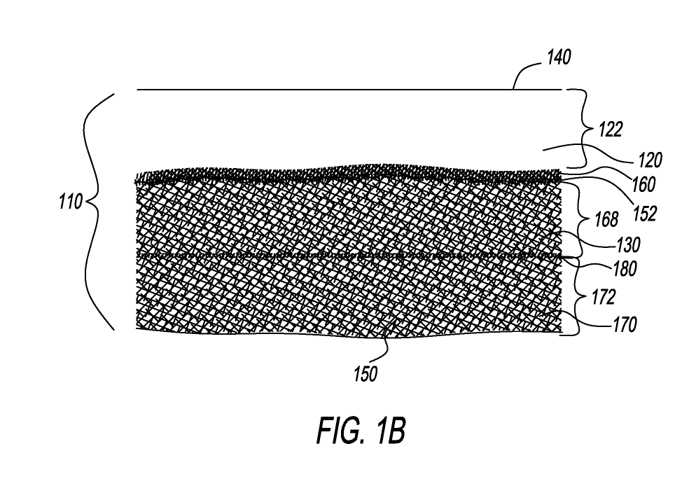

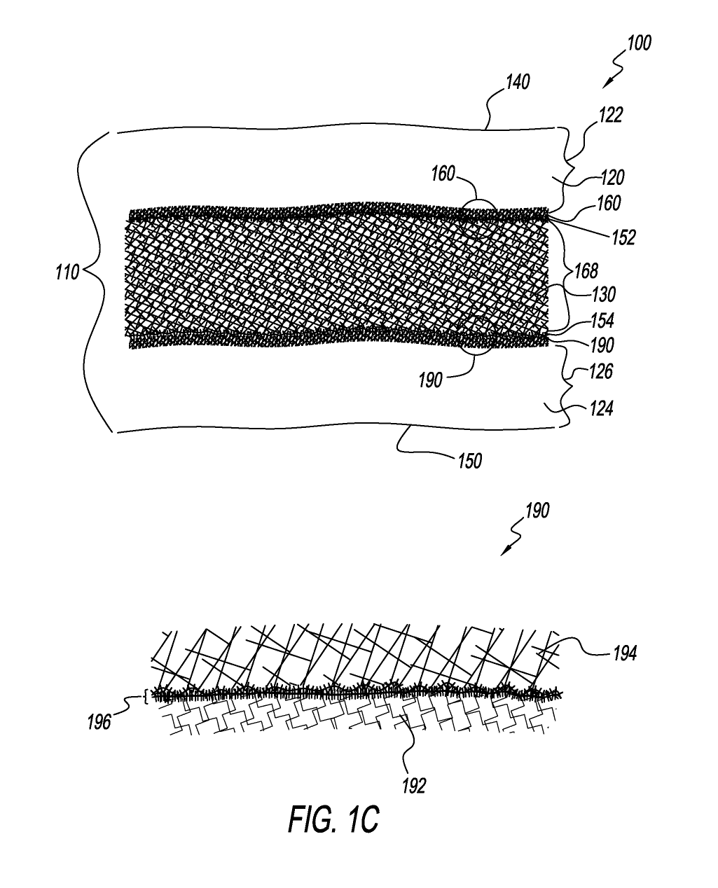

FIGS. 1A, 1B, and 1C illustrate cross-sectional views of exemplary embodiments of a layered building element in accordance with the present disclosure. A layered building element (100) may comprise a flexible sheet (110). FIG. 1A shows that the flexible sheet (110) may comprise a first elastomer layer (120) and a first fiberglass layer (130). A first thickness (122) of the first elastomer layer (120) and a first thickness (168) of the first fiberglass layer (130) are shown for exemplary purposes, only, and are not meant to be limiting. The respective thicknesses may reflect characteristics desired in the flexible sheet (110). For example, the first thickness (122) of the first elastomer layer (120) may be less than the first thickness (168) of the first fiberglass layer (130) to enhance strength or dimensional stability in the flexible sheet (110). In an alternative embodiment, the first thickness (122) of the first elastomer layer (120) may be substantially equal to or greater than the first thickness (168) of the first fiberglass layer (130) to enhance protective abilities against ultra violet rays. Accordingly, a flexible sheet may comprise layers, and each layer's relative thickness may support desired flexible sheet characteristics.

In an exemplary embodiment, a top-facing surface of the first elastomer layer (120) may form a top surface (140) of the flexible sheet (110). In an exemplary embodiment, the top surface (140) may comprise a texture or may be smooth depending on function or desired decorative characteristics of the layered building element (100). For example, the top surface (140) may comprise a texture to add traction for flat roof use or may comprise less texture for a substantially sloped roof use. In another exemplary embodiment, the top surface (140) may comprise a texture to support use as indoor or outdoor carpet tiles, non-carpet flooring tiles, or other indoor flooring. For example, in an embodiment of the present invention, the top surface texture for restaurant flooring or residential kitchen flooring may be similar or dissimilar to the top surface texture for office building flooring, hospital flooring, or other residential flooring uses. Similarly, in an embodiment, for example, a bottom-facing surface of the first fiberglass layer (130) may form a bottom surface (150) of the flexible sheet (110). In an exemplary embodiment, the bottom surface (150) may comprise a texture or may be smooth depending on the function of the first fiberglass layer (130). For example, a bottom surface (150) may comprise a woven texture to support applying the flexible sheet (110) to a building surface. Accordingly, a flexible sheet may comprise an elastomer layer and a fiberglass layer, and the layers may form top and bottom surfaces of the flexible sheet.

In an exemplary embodiment, the first elastomer layer (120) and the first fiberglass layer (130) may communicate at a top surface (152) of the first fiberglass layer (130) forming a first interface (160). FIG. 1A further shows an exemplary embodiment of the first interface (160). In an embodiment of the present invention, for example, the first interface (160) may comprise elastomeric material (162) from the first elastomer layer (120) and glass fibers (164) from the first fiberglass layer (130). In an exemplary embodiment, the first interface (160) may comprise glass fibers (164) impregnated with elastomeric material (162). In an embodiment, for example, the glass fibers (164) at the first interface (160) may be relatively uniformly or relatively non-uniformly impregnated with elastomeric material (162). In an embodiment of the present invention, characteristics of the first interface (160), such as the relative uniformity of the elastomeric material (162) impregnated glass fibers (164) may reflect characteristics of the elastomeric material (162), glass fibers (164), or the surrounding environment. In an embodiment, an interface thickness (166) may reflect, for example, viscosity of the elastomeric material (162), fiber density or length of the glass fibers (164), or humidity of the surrounding environment. Accordingly, characteristics of an elastomeric material, glass fibers, and a surrounding environment may impact the characteristics of an interface of an elastomer layer and a first fiberglass layer.

In an exemplary embodiment, the interface thickness (166) may reflect desired bonding characteristics of the first elastomer layer (120) to the first fiberglass layer (130). For example, a substantial thickness of the interface thickness (166) may reflect a desire for enhanced strength in binding the first elastomer layer (120) to the first fiberglass layer (130). In an alternative embodiment, the thickness of the interface thickness (166) may reflect desired flexibility and absorptive properties of the flexible sheet (110). For example, in an embodiment, the first interface (160) may comprise a substantially small portion of the first fiberglass layer (130) based on the relative thickness of the first interface thickness (166) to a first thickness (168) of the first fiberglass layer (130). To that end, for example, the bottom surface (150) of the flexible sheet (110) may comprise substantially minimal, if any, elastomeric material (162). In an embodiment, for example, the bottom surface (150) of the flexible sheet (110) may not be impregnated with elastomeric material (162), which may support a dry bottom surface (150) of the flexible sheet (110). Accordingly, a thickness of an interface between an elastomer layer and a first fiberglass layer relative to a thickness of the first fiberglass layer may support desired characteristics in a flexible sheet.

In an exemplary embodiment, FIG. 1B shows an alternative embodiment of a flexible sheet (110). In this embodiment, for example, the flexible sheet (110) may comprise a first elastomer layer (120), a first fiberglass layer (130), and a second fiberglass layer (170). The number of fiberglass layers is shown for exemplary purposes, and is not meant to be limiting. Indeed, in an exemplary embodiment, the number of fiberglass layers may reflect, for example, strength and flexibility characteristics desired in the flexible sheet (110). Further, a thickness of the first elastomer layer (120), a thickness of the first fiberglass layer (130), and a thickness of the second fiberglass layer (170) are shown for exemplary purposes, only, and are not meant to be limiting. In an embodiment, for example, the first fiberglass layer (130) may comprise a first thickness (168), and the second fiberglass layer (170) may comprise a second thickness (172). The first thickness (168) and the second thickness (172) may be substantially similar, the same, or substantially different. The respective thicknesses of the first fiberglass layer (130) and the second fiberglass layer (170) may reflect characteristics desired in the flexible sheet (110). Also, the respective glass fiber lengths and arrangements shown in the first fiberglass layer (130) and the second fiberglass layer (170) are shown for exemplary purposes, only, and are not meant to be limiting. In an embodiment, glass fibers in the first fiberglass layer (130) may be randomly arranged, flattened into a sheet, or woven into a fabric. Glass fibers in the second fiberglass layer (170) may be arranged similarly or differently relative to the glass fibers in the first fiberglass layer (130). For example, the first fiberglass layer (130) may comprise a veil layer, comprising long fibers, and the second fiberglass layer (170) may comprise fibers oriented to form a woven fiberglass fabric. Accordingly, fiberglass attributes for each fiberglass layer in a flexible sheet may reflect desired flexible sheet characteristics.

As described herein above with respect to FIG. 1A, and with reference to FIG. 1B, in an exemplary embodiment, a top-facing surface of a first elastomer layer (120) may form a top surface (140) of a flexible sheet (110). As shown in FIG. 1B, in an exemplary embodiment, a bottom-facing surface of a second fiberglass layer (170) may form a bottom surface (150) of the flexible sheet (110). In an exemplary embodiment, the first elastomer layer (120) and the first fiberglass layer (130) may communicate at a top surface (152) of the first fiberglass layer (130) forming a first interface (160), as described herein above with respect to FIG. 1A. With further reference to FIG. 1B, the first fiberglass layer (130) and the second fiberglass layer (170) may communicate at a first fiberglass interface (180). In an embodiment of the present invention, a plurality of layers of fiberglass may communicate to bind the plural fiberglass layers together. In an embodiment, for example, the first fiberglass layer (130) and the second fiberglass layer (170) may communicate at the first fiberglass interface (180) through a binder, or, for example, using friction between the two layers. The method of binding one layer of fiberglass to another layer of fiberglass is not meant to be limiting. Accordingly, a flexible sheet may comprise at least one fiberglass layer in communication with an elastomer layer at an interface.

In another exemplary embodiment, FIG. 1C shows that the flexible sheet (110) may comprise a first elastomer layer (120), a first fiberglass layer (130), and a second elastomer layer (124). In an exemplary embodiment a first thickness (122) of the first elastomer layer (120), a first thickness (168) of the first fiberglass layer (130), and a second thickness (126) of a second elastomer layer (124) are shown for exemplary purposes, only, and are not meant to be limiting. The respective thicknesses may reflect characteristics desired in the flexible sheet (110). In an exemplary embodiment, the first thickness (122) of the first elastomer layer (120) or the second thickness (126) of the second elastomer layer (124) may be substantially equal to or greater than each other or the first thickness (168) of the first fiberglass layer (130) to enhance protective abilities against waterproofing or ultra violet rays. Accordingly, a flexible sheet may comprise layers, and each layer's relative thickness may support desired flexible sheet characteristics.

As described herein above with respect to FIG. 1A, and with reference to FIG. 1C, in an exemplary embodiment, a top-facing surface of the first elastomer layer (120) may form a top surface (140) of the flexible sheet (110). In an embodiment, for example, a bottom-facing surface of the second elastomer layer (124) may form a bottom surface (150) of the flexible sheet (110). In an exemplary embodiment, the bottom surface (150) may comprise a texture or may be smooth depending on the function of the second elastomer layer (124). For example, a bottom surface (150) may comprise a textured or smooth surface to support applying the flexible sheet (110) to a building surface in a form, for example, as carpet tiles, flooring tiles, or shingles. Accordingly, a flexible sheet may comprise a plurality of elastomer layers and at least one fiberglass layer, and the elastomer layers may form top and bottom surfaces of the flexible sheet.

With further reference to FIG. 1C, in an exemplary embodiment, the second elastomer layer (124) and the first fiberglass layer (130) may communicate at a bottom surface (154) of the first fiberglass layer (130) forming a second interface (190). In an embodiment of the present invention, for example, the second interface (190) may comprise elastomeric material (192) from the second elastomer layer (124) and glass fibers (194) from the first fiberglass layer (130). In an embodiment, for example, the second interface (190) may comprise glass fibers (194) impregnated with elastomeric material (192). In an embodiment, for example, the glass fibers (194) at the second interface (190) may be relatively uniformly or relatively non-uniformly impregnated with elastomeric material (192). In an embodiment of the present invention, characteristics of the second interface (190), such as the relative uniformity of the elastomeric material (192) impregnated glass fibers (194) may reflect characteristics of the elastomeric material (192), glass fibers (194), or the surrounding environment. In an embodiment, a second interface thickness (196) may reflect, for example, viscosity of the elastomeric material (192), fiber density or length of the glass fibers (194), or humidity of the surrounding environment. Accordingly, characteristics of an elastomeric material, glass fibers, and a surrounding environment may impact characteristics of a second interface of a second elastomer layer and a first fiberglass layer.

In an exemplary embodiment, the second interface thickness (196) may reflect desired bonding characteristics of the second elastomer layer (124) to the first fiberglass layer (130). For example, a substantial thickness of the second interface thickness (196) may reflect a desire for enhanced strength in binding the second elastomer layer (124) to the first fiberglass layer (130). In an alternative embodiment, the thickness of the second interface thickness (196) may reflect desired flexibility and absorptive properties of the flexible sheet (110). For example, in an embodiment, the second interface (190) may comprise a substantially small portion of the first fiberglass layer (130) based on the relative thickness of the second interface thickness (196) to a first thickness (168) of the first fiberglass layer (130). Further, a thickness of the second interface thickness (196) may be substantially similar or substantially dissimilar to a thickness of the first interface thickness (166). In an exemplary embodiment, not meant to be limiting, the relative thickness of the first interface (160) to the second interface (190) may reflect desired characteristics, such as relative resistance to wear and tear when used as a shingle or carpet tile. Accordingly, a thickness of either a first interface between a first elasomter layer and a fiberglass layer, or a second interface between a second elastomer layer and the fiberglass layer, may support desired characteristics in a flexible sheet.

As discussed herein above in FIGS. 1A, 1B, and 1C, a first elastomer layer (120) and a first fiberglass layer (130) may communicate at a top surface (152) of the first fiberglass layer (130) to form a first interface (160). In an exemplary embodiment, the first interface (160) may result from mechanically binding the first elastomer layer (120) to the first fiberglass layer (130). For example, during application of the first elastomer layer (120) to the first fiberglass layer (130), elastomeric material (162) may saturate or may seep to a first interface thickness (166) of the first fiberglass layer (130). Once the elastomeric material (162) cures, the elastomer-impregnated fiberglass layer (130) at the interface (160) may benefit from characteristics of both the elastomeric material (162) and the fiberglass layer (130). In an exemplary embodiment, an amount of applied elastomeric material (162) may remain tangential to the fiberglass layer (130). In this way, once the first elastomer layer (120) and the elastomeric material (162) cure, the flexible sheet (110) may comprise a first elastomer layer (120), a fiberglass layer (130), and an interface (160) comprising elastomeric material (162) impregnated glass fibers (164). Accordingly, curing an applied elastomer may form an elastomer layer in communication with a first fiberglass layer, as well as elastomer-impregnated fiberglass interface between the elastomer layer and the first fiberglass layer.

As discussed herein above with respect to FIG. 1C, an exemplary embodiment of the present invention may comprise a flexible sheet, which may comprise a second elastomer layer. In an embodiment, for example, a second elastomer layer (124) and a first fiberglass layer (130) may communicate at a bottom surface (154) of the first fiberglass layer (130) to form a second interface (190). In an exemplary embodiment, the second interface (190) may result from mechanically binding the second elastomer layer (124) to the first fiberglass layer (130). For example, during application of the second elastomer layer (124) to the first fiberglass layer (130), elastomeric material (192) may saturate or may seep to a second interface thickness (196) of the first fiberglass layer (130). Once the elastomeric material (192) cures, the elastomer-impregnated fiberglass layer (130) at the interface (190) may benefit from characteristics of both the elastomeric material (192) and the fiberglass layer (130). In an exemplary embodiment, an amount of applied elastomeric material (192) may remain tangential to the fiberglass layer (130). In this way, once the second elastomer layer (124) and the elastomeric material (192) cure, the flexible sheet (110) may comprise at least a second elastomer layer (124), a fiberglass layer (130), and an interface (190) comprising elastomeric material (192) and impregnated glass fibers (194). Accordingly, curing an applied elastomer may form a second elastomer layer in communication with a first fiberglass layer, as well as a second elastomer-impregnated fiberglass interface between the second elastomer layer and the first fiberglass layer.

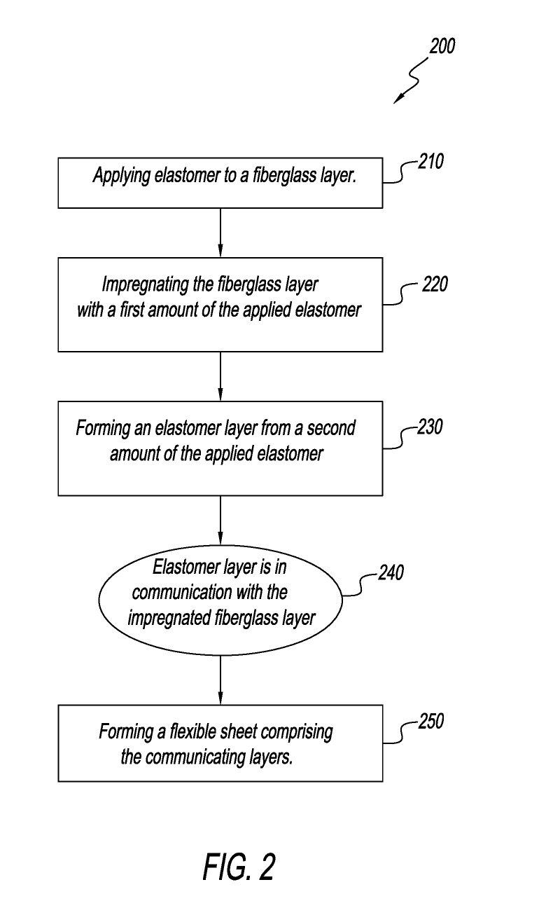

The layered building element (100) of the present invention illustrated in FIGS. 1A, 1B, and 1C may, in an exemplary embodiment, be formed off-site and transported for installation on an exterior or interior building surface. Benefits from off-site formation may include, but are not limited to, a clean forming environment and controlled application of an elastomer to a fiberglass layer. FIG. 2 illustrates a flow diagram showing making a layered building element (200) in accordance with the present disclosure. In an exemplary embodiment, making a layered building element (200) may comprise applying elastomer to a fiberglass layer (210). Referencing FIGS. 1A, 1B, and 1C, in an exemplary embodiment, single or multiple coats of an elastomeric material (162) may be applied to a top surface (152) of a first fiberglass layer (130) forming a first interface (160). An increase in elastomer coats applied to the fiberglass layer (210) may, in an exemplary embodiment, increase the waterproofing and strength characteristics of a flexible sheet (110). Accordingly, elastomer may be applied to a top surface of a fiberglass layer in coats, and the number of coats of applied elastomer may reflect desired characteristics of a flexible sheet.

If a building element comprises more than one elastomer layer, for example, as shown in FIG. 1C, applying elastomer to a fiberglass layer (210) may comprise applying elastomer to a top surface (152) of a first fiberglass layer (130) and to a bottom surface (154) of the first fiberglass layer (130). With reference to FIGS. 1B, and 1C, iIn another exemplary embodiment, a building element may comprise a plurality of fiberglass layers or a plurality of elastomer layers, and applying elastomer to a fiberglass layer (210) may comprise applying a first elastomer to a first side of a first fiberglass layer and a second elastomer to a second side of a second fiberglass layer. The number of either elastomer layers or fiberglass layers is provided herein for exemplary purposes, and is not meant to be limiting. Referencing FIG. 1C, in an exemplary embodiment, single or multiple coats of an elastomeric material (192) may be applied to a bottom surface (154) of a first fiberglass layer (130) forming a second interface (190). For example, an increase in elastomer coats applied to the fiberglass layer (210) may increase the waterproofing and strength characteristics of a flexible sheet (110). In an exemplary embodiment, coats of elastomer may be applied to both sides of a fiberglass layer, or to at least one side of each of a plurality of fiberglass layers, and the number of coats of applied elastomer may reflect desired characteristics of a flexible sheet. Accordingly, a flexible sheet may comprise elastomer applied to at least one side of at least one fiberglass layer.

In an embodiment, for example, making a layered building element (200) may further comprise impregnating the fiberglass layer with a first amount of the applied elastomer (220). Referencing FIGS. 1A, 1B, and 1C, in an exemplary embodiment, impregnating the fiber glass layer with a first amount of the applied elastomer (220) at a first interface (160) or a second interface (190) may comprise impregnating a portion or two portions of, for example, a first fiberglass layer (130). With reference to FIGS. 1A, 1B, and 1C, in an exemplary embodiment, a portion may comprise all or some amount less than a first thickness (168) of a first fiberglass layer (130). With reference to FIG. 1B, in an alternative embodiment, the portion may comprise all or some amount less than both the first thickness (168) of the first fiberglass layer (130) and a second thickness (172) of a second fiberglass layer (170). Accordingly, impregnating the fiberglass layer with a first amount of the applied elastomer may comprise impregnating all or an amount less than an entire thickness of a first fiberglass layer or more fiberglass layers.

With respect to FIGS. 1A, 1B, and 1C, in an exemplary embodiment of the present invention, the first amount is some fraction less than a total amount of applied elastomer to either a top surface (152) or a bottom surface (154) of a first fiberglass layer (130). With that in mind, making a layered building element (200) may further comprise forming an elastomer layer from a second amount of the applied elastomer (230). In an example, the second amount of applied elastomer added to the first amount of applied elastomer may comprise a substantial amount of the entire applied elastomer to either the tops surface (152) or the bottom surface (154) of the first fiberglass layer (130). The first amount may change with changes in, for example, elastomer viscosity or fiberglass density. Additionally, the first amount may change with changes in environmental temperature or humidity. With reference to FIGS. 1A, 1B, and 1C, a person of ordinary skill familiar with the art of applying curable fluids to fibrous material will appreciate the plethora of factors impacting an amount of applied elastomer ultimately impregnating at least a first fiberglass layer (130) a first interface (160) or a second interface (190). In an exemplary embodiment a resulting amount remaining may form, for example a first elastomer layer (120) on a top surface (152) of the first fiberglass layer (130) at a first interface (160). With respect to FIG. 1C, similarly, in an exemplary embodiment, a resulting amount may form, for example, a second elastomer layer (124) on a bottom surface (154) of the first fiberglass layer (130) at a second interface (190). Accordingly, a distribution of elastomer between forming an elastomer layer and impregnating a fiberglass layer may reflect desired characteristics of a flexible sheet, and may be responsive to multiple factors of the elastomer, fiberglass layer, and the environment.

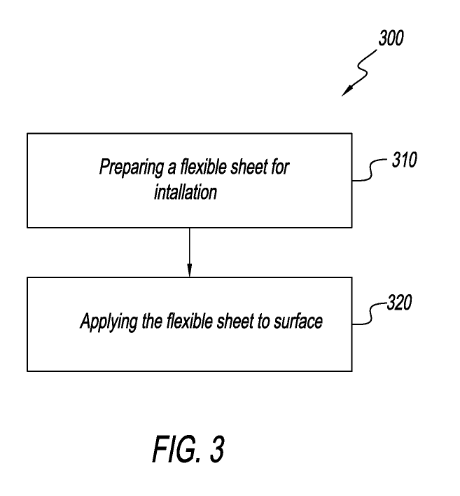

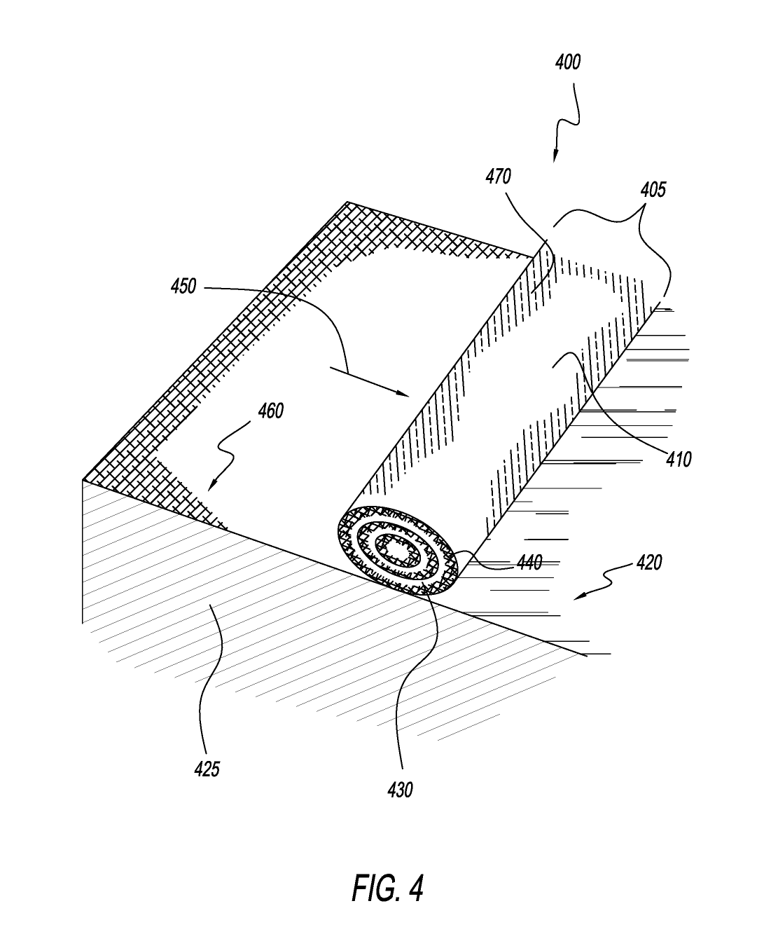

In an exemplary embodiment, the formed elastomer layer may be in communication with the elastomer-impregnated fiberglass layer (240). In an exemplary embodiment, making a layered building element (200) may further comprise forming a flexible sheet comprising the communicating layers (250). In a further exemplary embodiment, the flexible sheet may be shaped into, for example, shingles, tiles, or a substantially cylindrical roll. As described herein below with respect to FIGS. 3 and 4, in an exemplary embodiment, the substantially cylindrical roll may allow for ease of transporting the flexible sheet to a location for interior or exterior building surface installation. In a further embodiment, for example, the substantially cylindrical roll may be unrolled at an installation location and the flexible sheet may be installed at the location. In an embodiment, the substantially cylindrical roll may be transported to an installation site, at which point, the substantially cylindrical roll may be converted to tiles or shingles. Accordingly, making a layered building element may comprise forming a flexible sheet into a substantially cylindrical roll.

As described herein above, an exemplary embodiment of the present invention may apply an elastomer to a compatible substrate, such as fiberglass, in a controlled environment. In an embodiment, for example, curing of the elastomer may mechanically bond at least one formed elastomer layer to at least one fiberglass layer at at least one interface. As described herein above with respsect to FIGS. 1A, 1B, and 1C, cured elastomer layers may form one or both sides of a flexible sheet. The flexible sheet, described herein, may be transported to an installation site. Portability of the flexible sheet as described herein above may be necessary to leverage desired characteristics of a layered building element of the present invention on an exterior or interior building surface. Once installed, the flexible sheet, in view of the elastomer, fiberglass, and elastomer-impregnated fiberglass, may form a protective membrane. Accordingly, an installed flexible sheet may, for example, provide, at least, ultraviolet protection, waterproofing protection, strength, or durability to an exterior or interior building surface.

As described above, a layered building element of the present invention may be installed on a building structure. In an exemplary embodiment, the building structure may comprise a building surface. The surface, for example, may be a vertical surface, or substantially vertical surface. For example, in an embodiment of the present invention, an interior or exterior surface may comprise an interior wall, exterior wall or sloped roof. Building elements of the present invention forming protective membranes may comprise, for example, a wall sheet, roofing shingles, or other forms of roofing. Roofing shingles or other form of roofing of the present invention may reflect decorative, as well as desired ultraviolet, durability, and strength characteristics. Alternatively, for example, the surface may comprise a partially horizontal surface, or, alternatively, a substantially horizontal surface. For example, in an embodiment of the present invention, an exterior surface may comprise a flat roof. Similarly, an interior surface may comprise a floor, such as a restaurant floor, residential kitchen floor, hospital floor, or other residential or commercial floors. Building elements of the present invention forming protective membranes may comprise, for example, carpet tiles, floor tiles, or other forms of flooring. As with the vertical surfaces, flooring or tiles of the present invention may reflect decorative, as well as desired ultraviolet, durability, and strength characteristics. Accordingly, a layered building element of the present invention may be installed to protect both vertical and horizontal building surfaces.

In an exemplary embodiment of the present invention, an exterior surface may comprise a roof. The roof may directly interface with natural elements, such as rain, snow, hail, wind, or branches. The slope or incline of the roof may impact the level of destruction by these and other natural elements. For example, heavily sloped roofs may experience less snow damage than substantially horizontal or flat roofs. In an exemplary embodiment, flat roofs may be installed, for example, on residential or commercial buildings, recreational vehicles, or railcars. In some cases, flat roofs may be unable to efficiently and adequately drain rainwater or snow melt, causing standing water on an exterior roof surface. After a period of time, the standing water may cause damage to the roofing structure or substrate, such as leaks. These leaks may directly result in interior structure water damage. Accordingly, protecting flat roofs may involve providing at least waterproofing protection.

In an exemplary embodiment, flat roofs may also provide functions not associated with sloped roofs. For example, flat roofs may function as additional outdoor space, which may require nonslip characteristics. Every day events, such as walking on the flat roof, may weaken the structural integrity of the flat roof exterior surface. Further, ultra violet rays may penetrate a flat roof, thereby increasing a burden on an interior cooling system. Accordingly, exterior building surfaces, such as flat roofs, may require additional considerations in protecting the integrity of the roof function.

In an exemplary embodiment of the present invention, an interior surface may comprise a wall. For example, the wall may directly or indirectly communicate with water sources, such as holes in an exterior surface or rusted plumbing. Further, for example, the wall integrity may decay due to interior humidity. Accordingly, interior building surfaces, such as walls, may require additional considerations in protecting a wall from, for example, water damage.

In another exemplary embodiment, an interior surface may comprise a floor. A flexible sheet may comprise flooring as a membrane to protect, for example, commercial or residential floors, hospital floors, and kitchen or bathroom floors. Building elements of the present invention forming protective membranes may take a form as a carpet tile, non-carpet tile, or alternative flooring form. As with a flat roof, as described above, a floor may require non-slip characteristics, as well as durability or strength characteristics. Accordingly, interior building surfaces, such as floors, may require additional considerations in protecting the integrity of the floor function.

In an exemplary embodiment, a layered building element comprising a flexible sheet of the present invention may, as described herein above, protect, for example, a sloped roof, a low sloop or flat roof, or an interior floor. To install the flexible sheet, a substrate surface, such as, for example, wood for a sloped or flat roof substrate, or interior floor, may be cleaned and wet with adhesive. The flat sheet, in an embodiment as tiles, shingles, a single sheet, or multiple sheets, or any combination thereof, may be adhered to the sloped flat roof or floor substrate by making contact with the adhesive. Accordingly, a flexible sheet of the present may form shingles, tiles, sheets, or other forms to provide protective membranes for interior and exterior building surfaces.

In an embodiment of the present invention, a flexibility level of the flexible sheet may support ease of movement and installation of the flexible sheet. With reference to FIG. 1A, the flexibility level of the flexible sheet (110) may reflect, for example, a ratio of a first thickness (122) of a first elastomer layer (120) to a first thickness (168) of a first fiberglass layer (130), a first interface thickness (166), or any combination thereof. With reference to FIG. 1B, the flexibility level of the flexible sheet (110) may reflect, for example, a ratio of a first thickness (122) of a first elastomer layer (120) to a first thickness (168) of a first fiberglass layer (130), a first interface thickness (166), at least a second thickness (172) of a second fiberglass layer (170), a total thickness of at least a first fiberglass layer (130) and a second fiberglass layer (170), or any combination thereof. With reference to FIG. 1C, the flexibility level of the flexible sheet (110) may reflect, for example, a ratio of a first thickness (122) of a first elastomer layer (120) to a first thickness (168) of a first fiberglass layer (130), a second thickness (126) of a second elastomer layer (124) to a first thickness (168) of a first fiberglass layer (130), a first interface thickness (166), a second interface thickness (196), or any combination thereof. In an exemplary embodiment, the flexibility level of the flexible sheet may reflect other capabilities and characteristics of the elastomer and fiberglass layers, such as, but not limited to, capabilities and characteristics described above. For example, in an embodiment of the present invention, the flexibility level may reflect strength of a first elastomer layer (120), strength of at least a first fiberglass layer (130), strength of a second elastomer layer (124), or any combination thereof. The number of elastomer layers or fiberglass layers is provided for exemplary purposes, only, and is not meant to be limiting. Accordingly, a flexibility level of a flexible sheet may reflect attributes of the flexible sheet layer components.

In an exemplary embodiment of the present invention, the flat sheet may form tiles, shingles, or a substantially cylindrical roll. In an embodiment, for example, the roll may be transported from a manufacturing site to a building surface installation site in roll form. In an embodiment of the present invention, the roll may be unrolled prior to application to a structural building surface, such as a roof or floor. Accordingly, the layered building element of the present invention may be transported from a manufacturing site to an installation site for installation as a single piece or multi-piece protective membrane for an exterior or interior surface.

FIG. 3 illustrates a flow diagram showing installing a layered building element in accordance with the present disclosure (300). In an exemplary embodiment, installing a layered building element (300) may comprise preparing a flexible sheet for installation (310) and applying the flexible sheet to a surface (320). As discussed herein above with respect to FIGS. 1A, 1B, and 1C, in an exemplary embodiment of the present invention, a flexible sheet (110) may comprise a first elastomer layer (120) in communication with a first fiberglass layer (130) at a first interface (160). In an alternative embodiment, the flexible sheet (110) may comprise at least a first fiberglass layer (130) and a second fiberglass layer (170). In another exemplary embodiment, a flexible sheet (110) may comprise a first elastomer layer (120) in communication with a first fiberglass layer (130) at a first interface (160) and a second elastomer layer (124) in communication with the first fiberglass layer (130) at a second interface (190). With respect to FIGS. 1A, 1B, and 1C, the first interface (160) may comprise elastomeric material (162) impregnating glass fibers (164) to an interface thickness (166) of the fiberglass layer (130). With respect to FIG. 1C, a second interface (190) may comprise elastomeric material (192) impregnating glass fibers (194) of the fiberglass layer (130). Accordingly, installing a layered building element may comprise applying a flexible sheet, comprising at least one elastomer layer, at least a first fiberglass layer, and at least a first interface, to a surface.

With reference to FIGS. 1A, 1B, and 1C, as discussed above, a layered building element (100) may comprise a flexible sheet (110), which may comprise a top surface (140) and a bottom surface (150). In an exemplary embodiment of the present invention, the bottom surface (150) may communicate with a building surface substrate, such as wood or metal, either directly or indirectly. For example, in an embodiment of the present invention, the flexible sheet (110) may be applied to a building substrate by means of adhesive. In an embodiment, for example, the adhesive may chemically bond the bottom surface (150) of the flexible sheet (110) to the substrate. In an alternative embodiment, mechanical means may be employed to apply the flexible sheet (110) to a substrate or directly to an interior or exterior surface. For example, to enhance performance or roof appearance, applying a flexible sheet to a surface (320) may comprise using fasteners and trim strips, which may aid in, for example, securing edges, transitions, vents, or skylights. In another exemplary embodiment, applying the flexible sheet to a surface (320) may comprise adhering shingles to a roof surface. In an alternative exemplary embodiment, to enhance interior floor appearance or durability, applying a flexible sheet to a surface (320) may similarly comprise using trim strips. Once adhered to the building surface, the layered building element of the present invention may form a protective membrane across the exterior or interior surface. Leveraging characteristics of elastomer and fiberglass, the protective membrane may protect the building surface from natural element damage, water damage, or use damage for long periods of time. Accordingly, a flexible sheet may be affixed to exterior building surface to form a membrane protecting an exterior or interior surface.

In an embodiment of the present invention, for example, the flexible sheet may form a substantially cylindrical roll. FIG. 4 illustrates a perspective view showing unrolling a substantially cylindrical roll of a layered building element in accordance with the present invention (400), as described in FIG. 1A. In an exemplary embodiment, a flexible sheet (405) in a form of a substantially cylindrical roll (410) may be unrolled onto an exterior surface (420) of a building structure (425). The substantially cylindrical roll (410) may comprise an elastomer layer (430) in communication with a first fiberglass layer (440). In an exemplary embodiment of the present invention, the substantially cylindrical roll (410) may be unrolled in a first direction (450). In an embodiment, for example, unrolling the substantially cylindrical roll (410) in a first direction (450) may result in a top surface (460) of the elastomer layer (430) facing substantially away from the exterior surface (420) of the building structure. In an exemplary embodiment, unrolling the substantially cylindrical roll (410) in a first direction (450) may result in a bottom surface (470) of the first fiberglass layer (440) facing the exterior surface (420) of the building structure. In an exemplary embodiment of the present invention in accordance with FIGS. 1B, and 1C, a substantially cylindrical roll (410) may be unrolled onto an exterior surface (420) of a building structure (425), such that a top surface of a first elastomer layer may face substantially away from the exterior surface (420) and a bottom surface of a second fiberglass layer or bottom surface of a second elastomer layer may face the exterior surface (420). Accordingly, a flexible sheet formed into a substantially cylindrical roll may be unrolled in parallel with an exterior building surface, such that a top surface of an elastomer layer may communicate directly with natural elements and wear and tear sources.

The low slope of the exterior surface (420) is provided herein for exemplary purposes, only. As described herein above, the exterior surface (420) may be substantially vertical, substantially horizontal, or some alternative slope. Indeed, in an exemplary embodiment, the exterior surface (420) may comprise a horizontal surface. A horizontal surface may comprise, for example, a roof, such as a flat roof roof. Examples of flat roofs may comprise, but are not limited to, residential or business roofs, recreational vehicular roofs, or rail car roofs. Alternatively, in an embodiment, the exterior surface (420) may comprise a vertical surface, such as an exterior wall. Accordingly, a flexible sheet formed in a substantially cylindrical roll may be unrolled for installation on both horizontal and vertical exterior surfaces.

In an alternative exemplary embodiment, with reference to FIG. 4, a flexible sheet (405) in a form of a substantially cylindrical roll (410), as described herein above, may be unrolled onto an interior surface (not shown) of a building structure (425). The interior surface may be, for example, a horizontal surface, such as a floor, or a vertical surface, such as a wall. In an embodiment, for example, unrolling the substantially cylindrical roll (410) in a first direction (450) may result in a top surface (460) of an elastomer layer (430) facing substantially away from the interior surface (not shown) of the building structure. With reference to FIG. 1A, for example, in an exemplary embodiment, unrolling the substantially cylindrical roll (410) in a first direction (450) may result in a bottom surface (470) of a first fiberglass layer (440) facing an interior surface (not shown) of the building structure. With reference to FIGS. 1B or 1C, for example, in an exemplary embodiment, unrolling the substantially cylindrical roll (410) in a first direction (450) may result in a bottom surface second fiberglass layer or bottom surface of a second elastomer layer facing an interior surface (not shown) of the building structure. Accordingly, a flexible sheet formed into a substantially cylindrical roll may be unrolled in parallel with an interior building surface, such that a top surface of an elastomer layer may communicate directly with humidity or other water damage sources, as well as wear and tear sources.

In an exemplary embodiment, a layered building element of the present invention may comprise multiple flexible sheets of same, similar, or differing size dimensions. For example, in an embodiment, a single flexible sheet or a plurality of flexible sheets may comprise a single protective membrane on a horizontal or a vertical building surface, such as an exterior or interior surface. Installation of a plurality of flexible sheets of the present invention may comprise, for example, redundant layering. A plurality of flexible sheets of the present invention may be installed following a redundant layering approach, for example, around a skylight and supporting roof structure. In an embodiment, for example, installing a plurality of flexible sheets of the present invention may comprise an overlapped or a staggered layering approach. A plurality of flexible sheets of the present invention may be installed following an overlapped or staggered layering approach, for example, as with wall or roof shingles, shingles of any size, or floor tiles. A quantity of flexible sheets installed on a building surface may reflect each flexible sheet dimension, the building surface dimension, and a layering approach, such as redundant, overlapped, and staggered, or combinations thereof. Accordingly, a single flexible sheet or multiple flexible sheets may be installed on both horizontal and vertical building surfaces.

It is to be understood that the various embodiments shown and described herein are to be taken as exemplary. Elements and materials, and arrangements of those elements and materials, may be substituted for those illustrated and described herein, parts may be reversed, and certain features of the present disclosure may be utilized independently, all as would be apparent to one skilled in the art after having the benefit of the description herein. Changes may be made in the elements described herein without departing from the spirit and scope of the present disclosure and following claims, including their equivalents.

It is to be understood that the particular embodiments set forth herein are non-limiting, and modifications to structure, dimensions, materials, and methodologies may be made without departing from the scope of the present disclosure.

It is to be further understood that this description's terminology is not intended to limit the invention. For example, spatially relative terms, such as “front,” “back,” “top,” “bottom,” “side,” and the like, may be used to describe one element's or feature's relationship to another element or feature as intended to connote the orientation of, for example, the layered building element as illustrated in the figures.

For the purposes of this specification and appended claims, unless otherwise indicated, all numbers expressing quantities, percentages or proportions, and other numerical values used in the specification and claims, are to be understood as being modified in all instance by the term “about” if they are not already. That is, unless indicated to the contrary, the numerical parameters set forth in the specification and claims are approximations that may vary depending on the desired properties sought to be obtained by the present disclosure.

What is claimed is:

1. A layered building element comprising:
a flexible sheet comprising a first layer in communication with a second layer;
the first layer comprising a first elastomer; and
the second layer comprising a first fiberglass layer impregnated with the first elastomer.

2. The layered building element of claim 1, wherein the first elastomer is selected from the group consisting of polyurea, polyurethane, and combinations thereof

3. The layered building element of claim 1, wherein the flexible sheet further comprises at least a third layer comprising a second elastomer.

4. The layered building element of claim 3, wherein the flexible sheet forms roofing shingles.

5. The layered building element of claim 1, wherein the second layer further comprises at least a second fiberglass layer.

6. The layered building element of claim 1, wherein the flexible sheet forms a generally cylindrical roll.

7. A method of making a layered building element, the method comprising:
applying a first elastomer to a first fiberglass layer;
impregnating the first fiberglass layer with a first amount of the applied first elastomer;
forming a first elastomer layer from a second amount of the applied first elastomer, wherein the first elastomer layer is in communication with the impregnated first fiberglass layer; and
forming a flexible sheet comprising the communicating layers.

8. The method of claim 7, wherein the first elastomer is selected from the group consisting of polyurea, polyurethane, and combinations thereof.

9. The method of claim 7, further comprising binding at least a second fiberglass layer to the first fiberglass layer.

10. The method of claim 7, further comprising shaping the flexible sheet into a substantially cylindrical roll.

11. The method of claim 7, further comprising applying a second elastomer to the first fiberglass layer.

12. A method of installing a layered building element, the method comprising:
preparing a flexible sheet for installation, wherein the flexible sheet comprises a first layer in communication with a second layer;
the first layer comprising a first elastomer; and
the second layer comprising a first fiberglass layer impregnated with the first elastomer; and
applying the flexible sheet to a surface.

13. The method of claim 12, wherein the first elastomer is selected from the group consisting of polyurea, polyurethane, and combinations thereof.

14. The method of claim 12, wherein the flexible sheet further comprises a third layer comprising a second elastomer.

15. The method of claim 14, wherein the flexible sheet comprises roofing shingles.

16. The method of claim 12, further comprising forming the flexible sheet into a substantially cylindrical roll.

17. The method of claim 16, further comprising unrolling the substantially cylindrical roll on the surface.

18. The method of claim 12, wherein the second layer further comprises at least a second fiberglass layer.

19. The method of claim 12, wherein the surface comprises a substantially horizontal surface.

20. The method of claim 19, wherein the substantially horizontal surface is selected from the group consisting of a building roof, a rail car roof, and a recreational vehicle roof.
